(19) United States
(12) Patent Application Publication
(10) Pub. No.: US 2026/0036924 A1
(43) Pub. Date: Feb. 5, 2026

(54) MOUNTING STRUCTURE, DEVELOPING DEVICE, AND IMAGE FORMING APPARATUS

(71) Applicant: Yuuki TSUCHIYA, Kanagawa (JP)

(72) Inventor: Yuuki TSUCHIYA, Kanagawa (JP)

(21) Appl. No.: 19/286,301

(22) Filed: Jul. 31, 2025

(30) Foreign Application Priority Data
Aug. 5, 2024 (JP) 2024-128989

(51) Int. Cl. G03G 15/08; G03G 21/16

(52) U.S. Cl. CPC G03G 15/0891; G03G 21/1647; G03G 2215/0827; G03G 2221/163; G03G 2221/1657

(57) ABSTRACT

A mounting structure includes a rotation shaft, a bearing, and a power transmitter. The rotation shaft is of a conveyor that conveys powder. The rotation shaft has a first portion and a second portion. The first portion has a first outer circumferential surface. The second portion is adjacent to the first portion in an axial direction of the rotation shaft and has a second outer circumferential surface inside the first outer circumferential surface of the first portion in a cross-section orthogonal to the axial direction. The second outer circumferential surface has a non-circular cross section. The bearing is on the first portion of the rotation shaft and rotatably supports the rotation shaft. The power transmitter covers a part of the first outer circumferential surface of the first portion and is engaged with the second outer circumferential surface of the second portion to transmit a rotational force to the rotation shaft.

### CROSS-REFERENCE TO RELATED APPLICATION

This patent application is based on and claims priority pursuant to 35 U.S.C. § 119(a) to Japanese Patent Application No. 2024-128989, filed on Aug. 5, 2024, in the Japan Patent Office, the entire disclosure of which is hereby incorporated by reference herein.

### BACKGROUND

### Technical Field

The present disclosure relates to a mounting structure for mounting a bearing and a power transmitter on a rotation shaft of a conveyor for conveying powder, and a developing device and an image forming apparatus using the mounting structure.

### Related Art

In an image forming apparatus such as a copying machine or a printer, a mounting structure in which a bearing and a power transmitter are mounted on a rotation shaft of, for example, a conveying screw that conveys developer is adopted.

### SUMMARY

The present disclosure described herein provides a mounting structure that includes a rotation shaft, a bearing, and a power transmitter. The rotation shaft is of a conveyor that conveys powder. The rotation shaft has a first portion and a second portion. The first portion has a first outer circumferential surface. The second portion is adjacent to the first portion in an axial direction of the rotation shaft and has a second outer circumferential surface inside the first outer circumferential surface of the first portion in a cross-section orthogonal to the axial direction. The second outer circumferential surface has a non-circular cross section. The bearing is on the first portion of the rotation shaft and rotatably supports the rotation shaft. The power transmitter covers a part of the first outer circumferential surface of the first portion and is engaged with the second outer circumferential surface of the second portion to transmit a rotational force to the rotation shaft.

The present disclosure described herein also provides a developing device that includes the mounting structure and the conveyor. The conveyor conveys developer and includes the rotation shaft. The bearing rotatably supports the rotation shaft of the conveyor. The power transmitter transmits the rotational force to the conveyor.

The present disclosure described herein further provides an image forming apparatus that includes the developing device.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a schematic view of an image forming apparatus according to a first embodiment of the present disclosure;

FIG. 2 is a side cross-sectional view of a developing device according to the first embodiment of the present disclosure;

FIG. 3 is a front cross-sectional view of the developing device according to the first embodiment of the present disclosure;

FIG. 4 is a perspective view of one end of a conveying screw according to the first embodiment of the present disclosure;

FIG. 5 is a cross-sectional view of one end of the conveyor according to the first embodiment of the present disclosure;

FIG. 6 is a diagram illustrating a sectional shape of each of a first portion and a second portion of a rotation shaft of the conveying screw according to the first embodiment of the present disclosure;

FIG. 7 is a diagram illustrating a method of mounting a bearing and a gear according to the first embodiment of the present disclosure;

FIG. 8 is a diagram illustrating a method of mounting the bearing and the gear according to the first embodiment of the present disclosure;

FIG. 9 is a diagram illustrating a method of mounting the bearing and the gear according to the first embodiment of the present disclosure;

FIG. 10 is a diagram illustrating a method of mounting the bearing and the gear according to the first embodiment of the present disclosure;

FIG. 11 is a diagram illustrating a method of mounting the bearing and the gear according to the first embodiment of the present disclosure;

FIG. 12 is a diagram illustrating a method of mounting the bearing and the gear according to the first embodiment of the present disclosure;

FIG. 13 is a diagram illustrating an example in which a first portion has an inclined surface;

FIG. 14 is a diagram illustrating a state in which a guide for guiding a bearing is mounted on a rotation shaft of FIG. 13;

FIG. 15 is a diagram illustrating a state in which a bearing and a gear are mounted on the rotation shaft of FIG. 13;

FIG. 16 is a diagram illustrating an example in which each of a corner portion on an outer diameter side of a step of the rotation shaft and a corner portion of an opening edge of an insertion hole of the gear has an inclined surface inclined with respect to an axial direction;

FIG. 17 is a perspective view of a conveying screw according to a second embodiment of the present disclosure;

FIG. 18 is a diagram illustrating a state in which a bearing and a gear are mounted on the conveying screw according to the second embodiment of the present disclosure;

FIG. 19 is a perspective view of a conveying screw according to a third embodiment of the present disclosure;

FIG. 20 is a diagram illustrating a state in which a bearing and a gear are mounted on the conveying screw according to the third embodiment of the present disclosure;

FIG. 21 is a perspective view of a conveying screw according to a fourth embodiment of the present disclosure;

FIG. 22 is a diagram illustrating a state in which a bearing and a gear are mounted on the conveying screw according to the fourth embodiment of the present disclosure;

FIG. 23 is a schematic view of a bearing according to a fifth embodiment of the present disclosure;

FIG. 24 is a perspective view of one end of a conveying screw according to a comparative example; and

FIG. 25 is a perspective view of one end of a conveying screw according to another comparative example.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. In the drawings for illustrating embodiments of the present disclosure, identical or similar reference signs are assigned to elements such as components and parts that have identical or similar functions or shapes as far as distinguishable, and descriptions of such elements may be omitted once the description is provided. As used herein, the singular forms “a,” “an,” and “the” are intended to include the plural forms as well, unless the context clearly indicates otherwise.

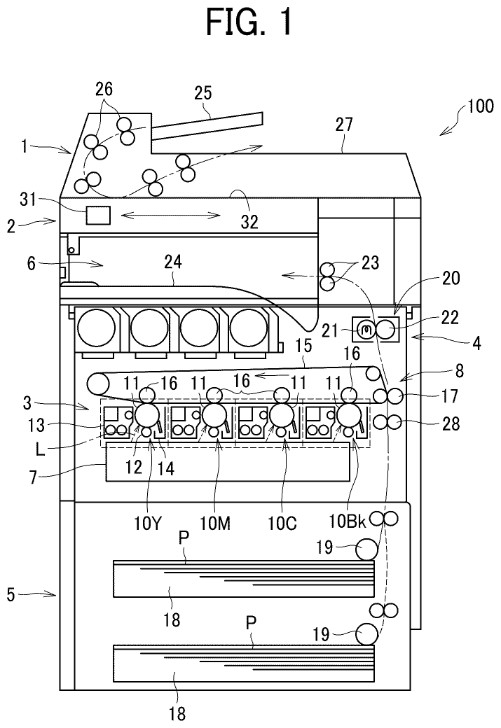

FIG. 1 is a schematic diagram illustrating an image forming apparatus 100 according to a first embodiment of the present disclosure.

Initially, with reference to FIG. 1, a description is given below of an overall configuration and operation of the image forming apparatus 100. In the following description, the term “image forming apparatus” includes a printer, a copier, a facsimile machine, printing machine, or a multifunction circumferential having at least two of printing, copying, scanning, and facsimile functions. The term “image formation” includes the formation of images with meanings such as characters and figures and the formation of images with no meanings such as patterns.

As illustrated in FIG. 1, the image forming apparatus 100 according to the present embodiment includes a document conveyor 1, an image reading device 2, an image forming device 3, a fixing unit 4, a recording medium feeding device 5, and a recording medium ejection device 6. The document conveyor 1 conveys a document. The image reading device 2 reads an image on the document. The image forming device 3 forms an image on a recording medium such as a sheet of paper. The fixing unit 4 fixes the image on the recording medium. The recording medium feeding device 5 feeds the recording medium. The recording medium ejection device 6 ejects the recording medium. The image reading device 2 may not be included in the image forming apparatus 100 but may be disposed away from the image forming apparatus 100 and be connected to the image forming apparatus 100 via wire or wireless.

The original document conveyor 1 includes a document tray 25 on which the document is placed, a plurality of conveying rollers 26 that convey the document from the document tray 25 toward an exposure glass 32 of the image reading device 2, and a document ejection tray 27 to which the document is ejected.

The image reading device 2 includes the exposure glass 32 and an optical scanning unit 31 that optically reads an image on the document placed on the exposure glass 32. The optical scanning unit 31 includes a light source that irradiates the document with light, and a charge-coupled device (CCD) that reads an image from the reflected light of the document. As an alternative to the CCD, another image sensor such as a close contact-type image sensor (CIS) may be employed as an image reader. The optical scanning unit 31 moves in directions indicated by the double-sided arrow in FIG. 1 (i.e., the sub-scanning direction) by a carriage as a drive device, to form an imaging element via a lens to form an image of the document.

The image forming device 3 includes four image forming units 10Y, 10M, 10C, and 10Bk, an image writing device 7, and a transfer device 8. Each of the image forming units 10Y, 10M, 10C, and 10Bk includes a photoconductor 11. The image writing device 7 writes an electrostatic latent image on the photoconductor 11 of each of the image forming units 10Y, 10M, 10C, and 10Bk. The transfer device 8 transfers an image onto the recording medium. The image forming units 10Y, 10M, 10C, and 10Bk form toner images of different colors such as yellow, magenta, cyan, and black corresponding to color separation components of a color image on the surfaces of the photoconductors 11. Specifically, each of the image forming units 10Y, 10M, 10C, and 10Bk includes the photoconductor 11 serving as an image bearer bearing the image on the surface of the photoconductor 11, a charging device 12 that charges the surface of the photoconductor 11, a developing device 13 that supplies toner as developer to the surface of the photoconductor 11 to form a toner image, and a cleaning device 14 that cleans the surface of the photoconductor 11. In FIG. 1, reference numerals are assigned to the charging device 12, the developing device 13, and the cleaning device 14 included in one image forming unit 10Y, whereas reference numerals for the charging device 12, the developing device 13, and the cleaning device 14 included in the image forming units 10M, 10C, and 10Bk that form magenta, cyan, and black toner images, respectively, are omitted.

The image writing device 7 includes a laser diode (LD) that irradiates the surface of the photoconductor 11 with light (laser beam) in order to form the electrostatic latent image. The transfer device 8 includes an intermediate transfer belt 15, primary transfer rollers 16, and a secondary transfer roller 17. The intermediate transfer belt 15 is an endless belt stretched by a plurality of rollers. The four primary transfer rollers 16 are disposed inside a loop formed by the intermediate transfer belt 15. As each of the primary transfer rollers 16 contacts the photoconductor 11 of each of the image forming units 10Y, 10M, 10C, and 10Bk via the intermediate transfer belt 15, a primary transfer portion (i.e., a primary transfer nip region) is formed between the intermediate transfer belt 15 and each photoconductor 11 of the image forming units 10Y, 10M, 10C, and 10Bk. On the other hand, the secondary transfer roller 17 contacts an outer circumferential surface of the intermediate transfer belt 15 to form a secondary transfer nip between the secondary transfer roller 17 and the intermediate transfer belt 15.

The fixing unit 4 includes a fixing device 20 that fixes a toner image on the recording medium by heating and pressing the recording medium onto which the toner image is transferred. The fixing device 20 includes a fixing rotator 21 and a pressure rotator 22. A heat source such as a heater heats the fixing rotator 21. The pressure rotator 22 is pressed against the fixing rotator 21 to form a fixing nip.

The recording medium feeding device 5 includes a recording medium tray 18 and a sheet feed roller 19. The recording medium tray 18 stores a sheet P (or sheets P) as a recording medium (or recording media). The sheet feed roller 19 feeds the sheet P from the recording medium tray 18. Examples of the “recording medium” include not only paper (sheet) but also an overhead projector (OHP) transparency sheet, a fabric, a metallic sheet, a plastic film, and a prepreg sheet including carbon fibers previously impregnated with resin. Examples of the “sheet” include thick paper, a postcard, an envelope, thin paper, coated paper (e.g., coat paper and art paper), and tracing paper, in addition to plain paper.

The recording medium ejection device 6 includes an ejection roller pair 23 and an output tray 24. The ejection roller pair 23 ejects the recording medium. The output tray 24 stacks the recording medium ejected by the ejection roller pair 23.

With reference to FIG. 1, a description is given of an image forming operation of the image forming apparatus 100 according to the first embodiment.

When the image forming apparatus 100 receives an instruction for image formation, the image reading device 2 reads an image information on a document. The image information read at this time is image information of the document conveyed from the document tray 25 to the exposure glass 32 or image information of the document placed on the exposure glass 32. When the document is conveyed from the document tray 25 to the exposure glass 32, the image information of the document is read by the optical scanning unit 31 when the document passes through a specified reading position on the exposure glass 32. On the other hand, when the document is placed on the exposure glass 32, the optical scanning unit 31 reads the image information of the document while moving along the exposure glass 32 in the directions of the double-sided arrow in FIG. 1. The image information read by the optical scanning unit 31 is sent to the image writing device 7 of the image forming device 3.

In the image forming device 3, the photoconductor 11 of each of the image forming units 10Y, 10M, 10C, and 10Bk starts rotating. Toner images of the respective colors are formed on the surfaces of the photoconductors 11 through a charging process by the charging devices 12, an exposure process by the image writing device 7, and a developing process by the developing devices 13. Specifically, the surface of the photoconductor 11 is charged to a uniform high potential by the charging device 12, and then the image writing device 7 irradiates the surface (charged surface) of the photoconductor 11 with laser light based on image information. As a result, the potential of the portion irradiated with the laser light is lowered, and an electrostatic latent image based on the image information is formed on the photoconductor 11. Then, toner is supplied from the developing device 13 to the electrostatic latent image, so that a toner image is formed on the surface of the photoconductor 11.

When the toner image formed on the photoconductor 11 of each of the image forming units 10Y, 10M, 10C, and 10Bk reaches the primary transfer nip formed at each of the respective primary transfer rollers 16Y, 16M, 16C, and 16Bk, along with rotation of the photoconductor 11 of each of the image forming units 10Y, 10M, 10C, and 10Bk, the toner images of the image forming units 10Y, 10M, 10C, and 10Bk are sequentially transferred onto the intermediate transfer belt 15 that is rotating. Thus, a full color toner image is formed on the intermediate transfer belt 15. The image formation is not limited to the case where a full-color image is formed using all of the four image forming units 10Y, 10M, 10C, and 10Bk, and a single-color image may be formed using any one of the image forming units 10Y, 10M, 10C, and 10Bk, or a two color or three color image may be formed using any two or three of the image forming units 10Y, 10M, 10C, and 10Bk. After the toner image is transferred onto the intermediate transfer belt 15, untransferred toner remaining on each photoconductor 11 is removed by the cleaning device 14.

The toner image transferred onto the intermediate transfer belt 15 is conveyed to the secondary transfer nip (the position of the secondary transfer roller 17) with the rotation of the intermediate transfer belt 15, and is transferred onto a recording medium (sheet P) supplied to the secondary transfer nip. The recording medium supplied to the secondary transfer nip is the sheet P supplied from the recording medium feeding device 5. In other words, the recording medium (sheet P) is fed and supplied from the recording medium tray 18 by the rotation of the sheet feed roller 19 of the recording medium feeding device 5. Specifically, the recording medium fed by the sheet feed roller 19 abuts against a timing roller pair 28 on the way to the secondary transfer nip, and the conveyance of the recording medium is temporarily stopped. Thereafter, the timing roller pair 28 rotates at a specified timing. The recording medium is supplied to the secondary transfer nip such that the recording medium timely meets the toner image on the intermediate transfer belt 15. As a result, the toner image on the intermediate transfer belt 15 is transferred onto the recording medium.

Thereafter, the recording medium is conveyed to the fixing unit 4, and is conveyed while being heated and pressed by the fixing rotator 21 and the pressure rotator 22, so that the toner image is fixed to the recording medium. The recording medium is conveyed to the recording medium ejection device 6 and ejected to the output tray 24 by the ejection roller pair 23. Thus, a series of image forming operations is completed.

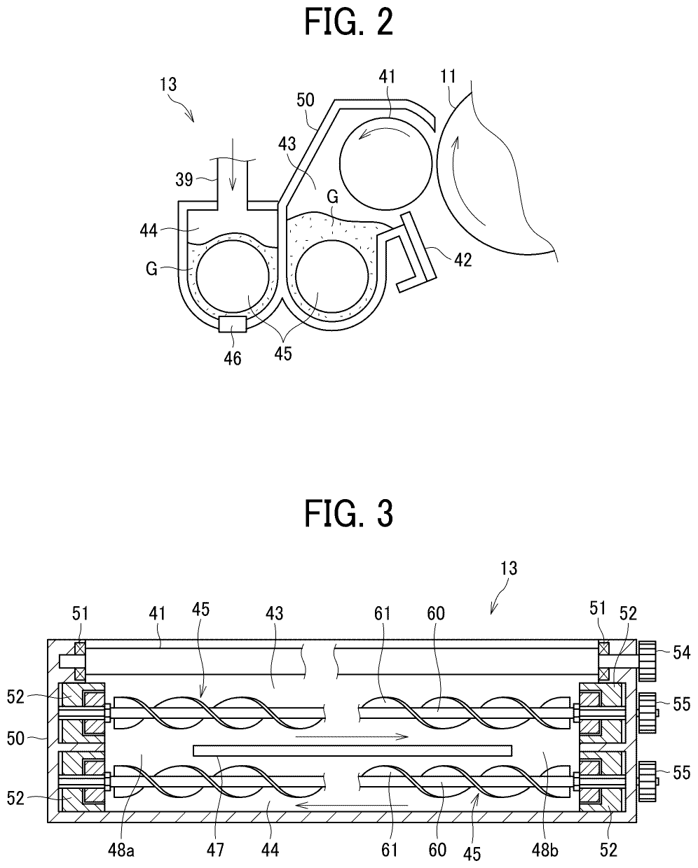

Next, with reference to FIGS. 2 and 3, a description is given of the configuration of the developing device 13 according to the first embodiment of the present disclosure.

FIG. 2 is a side cross-sectional view of the developing device 13 according to the first embodiment of the present disclosure. FIG. 3 is a front cross-sectional view of the developing device 13 according to the first embodiment of the present disclosure. The developing devices 13 included in the image forming units 10Y, 10M, 10C, and 10Bk illustrated in FIG. 1 have basically the same configuration except that the developing devices 13 store toners of different colors. Thus, a description is given below of the configuration of one developing device 13 illustrated in FIGS. 2 and 3 as an example.

As illustrated in FIG. 2, the developing device 13 according to the first embodiment of the present disclosure includes a developing roller 41 disposed to face the photoconductor 11, a regulation blade 42 facing the developing roller 41, a housing 50 having a developer housing 43 and a developer housing 44 in which developer G is stored, two conveying screws 45 disposed in the developer housing 43 and the developer housing 44, and a concentration detection sensor 46 that detects a toner concentration in the developer G. In the developing device 13 according to the first embodiment of the present disclosure, a two-component developer containing toner and carrier is used as the developer G.

The developing roller 41 is an example of a developer bearer that bears developer on the surface of the developing roller 41. The developing roller 41 includes magnets and a sleeve. The magnets are fixed inside the developing roller 41. The sleeve rotates around the magnets. As illustrated in FIG. 3, the developing roller 41 is supported by a pair of bearings 51 at both ends in the axial direction to be rotatable with respect to the housing 50. At one end of the developing roller 41 in the axial direction, a gear 54 as a power transmitter for transmitting a rotational force obtained from a driving source disposed in the body of the image forming apparatus 100 to the developing roller 41 is disposed.

The regulation blade 42 is an example of a regulator that regulates the amount of toner carried on the surface of the developing roller 41. As illustrated in FIG. 2, the regulation blade 42 is disposed to face the surface of the developing roller 41 with a specified gap between the regulating blade 42 and the developing roller 41.

The two conveying screws 45 are an example of a conveyor that conveys developer. As illustrated in FIG. 3, each of the conveying screws 45 includes a rotation shaft 60 and a spiral blade 61 on an outer circumferential surface of the rotation shaft 60. The rotation shaft 60 is made of a metal rod-shaped member, and the blade 61 is made of a resin material.

A pair of bearings 52 that rotatably support the rotation shaft 60 are mounted on both ends of the rotation shaft 60. A gear 55 as a power transmitter for transmitting a rotational force obtained from a driving source of the body of the image forming apparatus 100 to the rotation shaft 60 is mounted on one end of the rotation shaft 60.

As illustrated in FIG. 3, the one developer housing 43 and the other developer housing 44 are partitioned from each other by a partition 47 disposed between the developer housing 43 and the developer housing 44. However, the developer housing 43 and the developer housing 44 communicate with each other through a communication opening 48a and a communication opening 48b on both ends of the partition 47 in the longitudinal direction. As illustrated in FIG. 2, the concentration detection sensor 46 is disposed in one developer housing 44, and a toner supply path 39 for supplying toner to the developing device 13 is coupled to the developer housing 44.

The fixing device 13 according to the first embodiment of the present disclosure operates as follows.

When the conveying screws 45 in the developer housing 43 and the developer housing 44 are rotated, toner in the developer housing 43 and the developer housing 44 is conveyed while being stirred together with carrier, and is charged by friction with the carrier. The charged toner is attracted to the carrier, and is attracted to and carried on the surface of the developing roller 41 together with the carrier by the magnetic force of the magnet of the developing roller 41. When the developing roller 41 rotates in the direction indicated by the arrow in FIG. 2, the developer G on the developing roller 41 moves in the direction of rotation of the developing roller 41 as the developing roller 41 rotates.

Thereafter, when the developer G on the developing roller 41 reaches the position of the regulation blade 42, the excess developer G is scraped off by the regulation blade 42, and the amount of the developer G is regulated to an appropriate amount. When the developer G reaches a position (developing region) where the developing roller 41 and the photoconductor 11 face each other, toner is transferred to the photoconductor 11 by an electric field formed between the developing roller 41 and the photoconductor 11, and the electrostatic latent image on the photoconductor 11 is developed as a toner image by the transferred toner. The developer G that has remained on the developing roller 41 without being transferred to the photoconductor 11 is conveyed into the developer housing 43 with the rotation of the developing roller 41, and is separated from the developing roller 41 and stored in the developer housing 43.

When the toner is consumed and the percentage of the toner contained in the developer G (the toner concentration) decreases, the toner is supplied from a toner container such as a toner bottle to the developing device 13. When the toner concentration detected by the concentration detection sensor 46 is lower than a specified value, the toner is supplied from the toner container into the developer housing 44 via the toner supply path 39.

When the toner is supplied into the developer housing 44, the supplied toner is conveyed by the two conveying screws 45 to circulate in the developer housing 43 and the developer housing 44 together with the developer G in the developing device 13. In other words, as indicated by the arrows in FIG. 3, the one conveying screw 45 and the other conveying screw 45 convey the developer G in opposite directions, so that the developer G stored in the upper developer housing 43 and the developer G stored in the lower developer housing 44 are conveyed to circulate in the developing device 13 via the left communication opening 48a and the right communication opening 48b. Accordingly, when new toner is supplied into the developer housing 44 via the toner supply path 39, the supplied toner and the developer G are conveyed to circulate in the developing device 13, so that the toner and the developer G are stirred and mixed, and the percentage of the toner in the developer G (the toner concentration) is adjusted to be within a specified range.

With reference to a comparative example different from an embodiment of the present disclosure, a description is given of a disadvantage regarding a mounting structure of the bearing and the gear to the conveying screw.

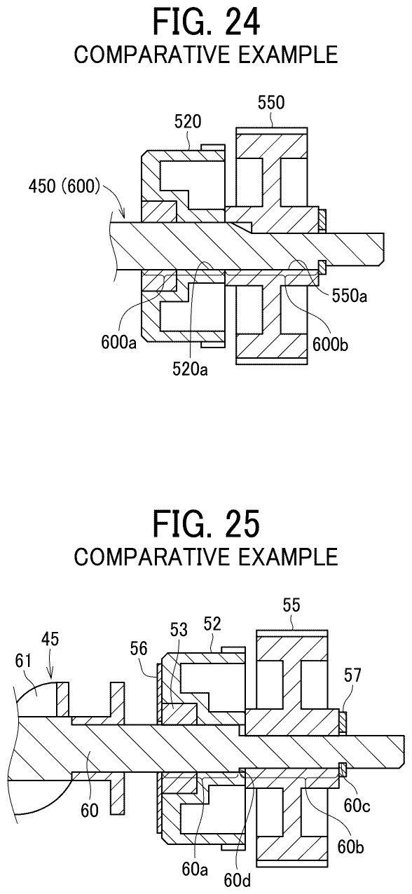

FIG. 24 is a cross-sectional view of one end of a conveying screw according to a comparative example.

As illustrated in FIG. 24, in a conveying screw 450 according to the comparative example, a bearing 520 and a gear 550 are mounted on one end of the conveying screw 450, similarly to the conveying screw according to the first embodiment of the present disclosure described above. The bearing 520 and the gear 550 have an insertion hole 520a and an insertion hole 550a, respectively, through which a rotation shaft 600 of the conveying screw 450 is inserted. In this case, the rotation shaft 600 is inserted into the insertion hole 520a of the bearing 520 and the insertion hole 550a of the gear 550 in the order of the bearing 520 and the gear 550, so that the bearing 520 and the gear 550 are mounted onto the outer circumferential surface of the rotation shaft 600.

In the comparative example, the bearing 520 is a sliding bearing that is slidably and rotatably mounted on a bearing mounting portion 600a of the rotation shaft 600, so that the bearing mounting portion 600a of the rotation shaft 600 and the insertion hole 520a of the bearing 520 have circular cross sections that are relatively rotatable. On the other hand, the gear 550 is integrally mounted on a gear mounting portion 600b of the rotation shaft 600 not to slide and rotate relative to the rotation shaft 600. For this reason, the gear mounting portion 600b of the rotation shaft 600 is formed to have a non-circular cross section of a substantially D-shaped cross section called a D-cut. The insertion hole 550a of the gear 550 formed in a substantially D-shaped cross section is fitted into the gear mounting portion 600b formed in a substantially D-shaped cross section in the same manner. Thus, the inner circumferential surface of the gear 550 (the insertion hole 550a) is locked to the outer circumferential surface of the gear mounting portion 600b, and the gear 550 is mounted onto the rotation shaft 600 not to rotate.

The bearing 520 and the gear 550 are preferably mounted on the rotation shaft 600 of the conveying screw 450 without rattling. For this reason, strict dimensional tolerances are set for forming the outer circumferential surface of the rotation shaft 600, the inner circumferential surface of the bearing 520, and the inner circumferential surface of the gear 550. For example, in the comparative example, when the outer circumferential surface of the rotation shaft 600 is set to satisfy a strict dimensional tolerance of ±0.025 mm over the entire area in the axial direction, the inner circumferential surfaces of the bearing 520 and the gear 550 are also formed with a strict dimensional tolerance of ±0.025 mm over the entire area in the axial direction.

The dimensional tolerances of the rotation shaft and the components mounted on the rotation shaft are tightened in this way, so that the mounting state of the components on the rotation shaft can be preferably maintained. However, when the dimensional tolerances are tightened, the degree of difficulty in processing increases, and thus a disadvantage of an increase in manufacturing cost occurs.

In an embodiment of the present disclosure, the following mounting structure is proposed in order to relax the dimensional tolerances of the components while maintaining a preferable mounting state of the components with respect to the rotation shaft. A description is given below of a mounting structure according to an embodiment of the present disclosure, with an example of a configuration according to the first embodiment of the present disclosure.

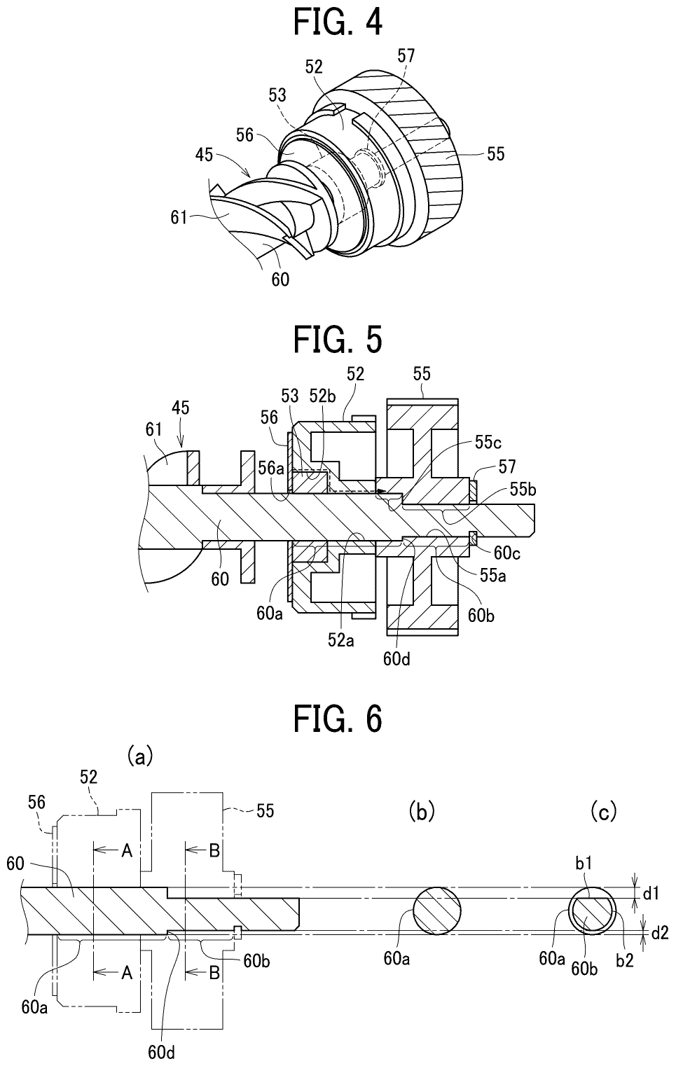

First, with reference to FIG. 4, a description is given of components mounted on the conveying screw 45 in the first embodiment of the present disclosure.

FIG. 4 is a perspective view of one end of the conveying screw 45 according to the first embodiment of the present disclosure.

As illustrated in FIG. 4, the bearing 52, the gear 55, a seal 53, a sheet member 56, and a retaining member 57 are mounted on one end of the rotation shaft 60 of the conveying screw 45 according to the first embodiment of the present disclosure. The sliding bearing that rotates in a sliding manner relative to the outer circumferential surface of the rotation shaft 60 of the conveying screw 45 is used as the bearing 52. The gear 55 is a power transmitter that is integrally mounted on the rotation shaft 60 and transmits a rotational force to the rotation shaft 60. The gear 55 has a plurality of teeth on its outer circumferential surface, which mesh with a drive gear disposed on the body of the image forming apparatus. The seal 53 is an annular seal that seals the gap between the outer circumferential surface of the rotation shaft 60 and the inner circumferential surface of the bearing 52 to prevent developer from leaking to the outside (on the side of the gear 55). As the seal 53, for example, a seal made of rubber as described in Japanese Unexamined Patent Application Publication No. 2006-171582, or a fibrous seal as described in Japanese Patent No. 7465447, is used. The sheet member 56 is a sheet made of resin such as polyethylene terephthalate (PET) attached to cover the seal 53. The retaining member 57 is a member that restricts the bearing 52 and the gear 55 from coming off from the rotation shaft 60.

FIG. 5 is a cross-sectional view of one end of the conveying screw 45 according to the first embodiment of the present disclosure.

As illustrated in FIG. 5, the seal 53 is interposed between the outer circumferential surface of the rotation shaft 60 and the inner circumferential surface of the bearing 52. An annular recess 52b to which the seal 53 is attached is formed on the inner circumferential surface of the bearing 52. In the first embodiment of the present disclosure, the recess 52b is open toward the inside in the axial direction of the rotation shaft 60 (the left in FIG. 5), the seal 53 can be pushed from an opening side of the recess 52b and attached in the recess 52b. The seal 53 is press-fitted into the recess 52b to be united with the bearing 52. For this reason, when the rotation shaft 60 rotates, the seal 53 slides relative to the outer circumferential surface of the rotation shaft 60 while being in close contact with the outer circumferential surface of the rotation shaft 60. The seal 53 may be fixed to the recess 52b by an adhesive, instead of being press-fitted into the recess 52b.

The seal 53 is press-fitted into the bearing 52 to be in close contact with the bearing 52, so that developer does not enter between the seal 53 and the bearing 52. However, depending on a variation in components dimensions, a gap may occur between the seal 53 and the bearing 52. In this case, as indicated by a dashed arrow in FIG. 5, the developer may leak to the outside through the gap between the seal 53 and the bearing 52.

Accordingly, in the first embodiment of the present disclosure, the sheet member 56 is disposed to cover the gap between the seal 53 and the bearing 52 on the opening side (the inner side in the axial direction) of the recess 52b. The sheet member 56 is an annular sheet having a hole 56a through which the rotation shaft 60 is inserted at the center, and is attached to the inner surface of the bearing 52 in the axial direction (the left in FIG. 5) to cover the gap between the seal 53 and the bearing 52. In this way, the sheet member 56 is attached to the inner side of the bearing 52 in the axial direction to cover the gap between the seal 53 and the bearing 52. Thus, the developer can be prevented from entering the gap between the seal 53 and the bearing 52, and the developer is more reliably prevented from leaking to the outside.

The bearing 52 and the gear 55 have an insertion hole 52a and an insertion hole 55a through which the rotation shaft 60 is inserted. The rotation shaft 60 is inserted through the insertion hole 52a of the bearing 52 and the insertion hole 55a of the gear 55 in this order, so that the bearing 52 and the gear 55 are mounted onto the outer circumferential surface of the rotation shaft 600. In a state where the bearing 52 and the gear 55 are mounted on the outer circumferential surface of the rotation shaft 60, the retaining member 57 is fitted into and locked to an engagement groove 60c of the outer circumferential surface of the rotation shaft 60. Thus, the gear 55 and the bearing 52 can be prevented from falling off from the rotation shaft 60.

In the first embodiment of the present disclosure, the rotation shaft 60 has a first portion 60a having a large-diameter outer circumferential surface on which the bearing 52 is mounted, and a second portion 60b having a small-diameter outer circumferential surface on which the gear 55 is mounted.

FIG. 6 is a diagram illustrating a cross-sectional shape of the first portion 60a and the second portion 60b in the rotation shaft 60 of the conveying screw 45 according to the first embodiment of the present disclosure. In FIG. 6, part (b) is a cross-sectional view of the rotation shaft 60 illustrated in part (a) taken along the first portion 60a (the position of line A-A), and part (c) is a cross-sectional view of the rotation shaft 60 illustrated in part (a) taken along the second portion 60b (the position of line B-B).

As illustrated in part (b) of FIG. 6, the first portion 60a of the rotation shaft 60 has a circular cross section. On the other hand, the second portion 60b of the rotation shaft 60 illustrated in part (c) of FIG. 6 has a non-circular and substantially D-shaped cross section in which a part of a circle is linearly cut out.

As illustrated in part (c) of FIG. 6, the second portion 60b has an outer circumferential surface having a smaller diameter than the diameter of the first portion 60a. In this case, the second portion 60b has an outer circumferential surface having an arc concentric with the outer circumferential surface of the first portion 60a. The diameter of the outer circumferential surface of the second portion 60b is smaller than the diameter of the outer circumferential surface of the first portion 60a over the entire circumference thereof. In other words, the outer circumferential surface of the second portion 60b is located inside the outer circumferential surface of the first portion 60a when viewed from the axial direction. In particular, a straight portion b1 of the outer circumferential surface of the second portion 60b is formed such that the distance from the outer circumferential surface of the first portion 60a to the straight portion b1 (i.e., a distance d1) is larger than the distance from the outer circumferential surface of the first portion 60a to an arc portion b2 (i.e., a distance d2), that is, the relation of “d1>d2” is satisfied. The outer circumferential surface of the arc portion b2 and the outer circumferential surface of the first portion 60a are formed to be spaced apart from each other by the distance d2. In this way, the diameter of the outer circumferential surface of the first portion 60a is formed to be smaller than the diameter of the outer circumferential surface of the first portion 60a over the entire circumference. Thus, an annular step 60d is formed between the first portion 60a and the second portion 60b.

In the first embodiment of the present disclosure, the second portion 60b is formed to have a non-circular and substantially D-shaped cross section. When the gear 55 is mounted onto the outer circumferential surface of the second portion 60b as illustrated in FIG. 5, the inner circumferential surface of the gear 55 is locked to the outer circumferential surface of the second portion 60b, and the rotation of the gear 55 with respect to the rotation shaft 60 is restricted. Specifically, the inner circumferential surface of the gear 55 (the insertion hole 55a) is formed to have a substantially D-shaped cross section similarly to the second portion 60b. When the gear 55 is mounted onto the outer circumferential surface of the second portion 60b, the inner circumferential surface of the gear 55 and the linear portion (the planar portion) of the cross section of the second portion 60b engage with each other. Thus, the rotation of the gear 55 with respect to the rotation shaft 60 is restricted. In this way, the second portion 60b functions as a rotation restricting portion that restricts the rotation of the gear 55. The cross-sectional shape of the second portion 60b may be a shape other than the substantially D-shape, such as a polygonal shape, as long as the cross-sectional shape is a non-circular cross-sectional shape. The straight portion b1 is positioned above the center of the second portion 60b. However, the position is not limited to that illustrated in FIG. 6, and may be any position as long as the gear 55 can be prevented from rotating with respect to the rotation shaft 60.

On the other hand, the first portion 60a of the rotation shaft 60 is formed to have a circular cross section, and thus, as illustrated in FIG. 5, in a state where the bearing 52 is mounted on the outer circumferential surface of the first portion 60a, the bearing 52 is held to be rotatable relative to the outer circumferential surface of the first portion 60a. The inner circumferential surface of the bearing 52 (insertion hole 52a) is also formed to have a circular cross section having substantially the same diameter as the outer circumferential surface of the first portion 60a.

As illustrated in FIG. 5, in a state where the gear 55 is mounted on the rotation shaft 60, the gear 55 is disposed to cover the outer circumferential surface of a part of the first portion 60a. For this reason, the gear 55 has a large-diameter inner circumferential surface 55c that covers the outer circumferential surface of the first portion 60a, and a small-diameter inner circumferential surface 55b having a smaller diameter than the large-diameter inner circumferential surface 55c. The small-diameter inner circumferential surface 55b is a portion that is locked to the second portion 60b, and is formed to have a substantially D-shaped cross section similarly to the second portion 60b. On the other hand, the large-diameter inner circumferential surface 55c is a portion that covers the first portion 60a having a circular cross section, and is formed to have a circular cross section similarly to the first portion 60a.

In the first embodiment of the present disclosure, the small-diameter inner circumferential surface 55b locked to the second portion 60b serves to fix the gear 55 to the rotation shaft 60, so that the large-diameter inner circumferential surface 55c does not need to be locked to the outer circumferential surface of the first portion 60a. For this reason, the large-diameter inner circumferential surface 55c is formed to have a circular cross section having a diameter that is substantially equal to the outer diameter of the first portion 60a (a diameter that is not locked even when the large-diameter inner circumferential surface 55c contacts the outer circumferential surface of the first portion 60a) or larger than the outer diameter of the first portion 60a. In other words, the fitting tolerance between the gear 55 (the large-diameter inner circumferential surface 55c) and the portion of the first portion 60a covered with the gear 55 is set to be larger than the fitting tolerance between the gear 55 (the small-diameter inner circumferential surface 55b) and the second portion 60b to which the gear 55 is locked.

In this way, in the first embodiment of the present disclosure, the fitting tolerance between the first portion 60a and the gear 55 (the large-diameter inner circumferential surface 55c) can be set larger than the fitting tolerance between the second portion 60b and the gear 55 (the small-diameter inner circumferential surface 55b). Thus, the dimensional tolerance of the inner diameter of the large-diameter inner circumferential surface 55c can be relaxed more than the dimensional tolerance of the inner diameter of the small-diameter inner circumferential surface 55b. For example, the dimensional tolerance of ±0.025 mm is kept for the small-diameter inner circumferential surface 55b, whereas the dimensional tolerance can be relaxed to ±0.1 mm for the large-diameter inner circumferential surface 55c. Accordingly, in the first embodiment of the present disclosure, compared to the configuration (FIG. 24) in which a strict dimensional tolerance (for example, the dimensional tolerance of ±0.025 mm) is set over the entire inner circumferential surface of the gear 550 as in the above-described comparative example, the dimensional tolerance of a part of the inner circumferential surface of the gear 55 (the large-diameter inner circumferential surface 55c) can be relaxed. Thus, the manufacturing cost of the gear 55 can be reduced. In the first embodiment of the present disclosure, the outer circumferential surface of the rotation shaft 60 is formed to be completely distinguished (sectioned) into the first portion 60a and the second portion 60b, the outer circumferential surface of the second portion 60b to which the gear 55 is locked can be formed to be rougher than the first portion 60a on which the bearing 52 is mounted. On the other hand, in a configuration in which the outer circumferential surface of the rotation shaft 600 is continuous on the same surface over the bearing mounting portion 600a and the gear mounting portion 600b (except for the D-cut portion) as in the comparative example, it is difficult to perform the treatment for making the bearing mounting portion 600a and the gear mounting portion 600b different in the surface roughness. For this reason, in the configuration of the comparative example, the gear mounting portion 600b is also generally processed to have a smooth surface profile in accordance with the roughness of the bearing mounting portion 600a. On the other hand, in the first embodiment of the present disclosure, the outer circumferential surfaces of the first portion 60a and the second portion 60b of the rotation shaft 60 are completely distinguished from each other. Thus, it is easy to perform the treatment for making the first portion 60a and the second portion 60b different in the surface roughness. According to the configuration of the first embodiment of the present disclosure, the surface roughness of a part of the rotation shaft 60 (the second portion 60b) can be roughened, and thus the cost for surface processing can be reduced.

In the configuration in which a part of the gear 55 is disposed to cover a part of the first portion 60a as in the first embodiment of the present disclosure, the sliding area between the bearing 52 and the rotation shaft 60 can be maintained even if the bearing 52 is displaced in the axial direction. A description is given below of the configuration with reference to another comparative example illustrated in FIG. 25.

The comparative example illustrated in FIG. 25 is an example in which the gear 55 is disposed not to cover the first portion 60a, unlike the first embodiment of the present disclosure. In this case, the gear 55 is disposed on the second portion 60b because the gear 55 does not cover the first portion 60a.

As a method of positioning the gear 55 in the axial direction of the rotation shaft 60, a method of sandwiching the gear 55 between the step 60d of the rotation shaft 60 and the retaining member 57 and fixing the gear 55 not to move in the axial direction is preferable from the viewpoint of assemblability of components. However, since there are variations in the dimensions of the components such as the retaining member 57, the gear 55, and the rotation shaft 60, the gear 55 may be mounted at a position shifted to the right from the step 60d as illustrated in FIG. 25. In this case, the bearing 52, which is positioned by abutting against the end surface of the gear 55, is similarly displaced to the right in accordance with the displacement of the gear 55. With such a configuration, a part of the bearing 52 protrudes to the right from the step 60d of the rotation shaft 60. A portion that does not contact the outer circumferential surface of the first portion 60a is generated on the inner circumferential surface of the bearing 52. In this case, the sliding area of the bearing 52 with respect to the rotation shaft 60 (the first portion 60a) is smaller than the sliding area in the case where the bearing 52 is disposed at the original position. Thus, the load on the sliding surface increases, and there is a concern that durability may decrease. When the bearing 52 is displaced to the right, the inner circumferential surface of the bearing 52 contacts a corner of the step 60d of the rotation shaft 60, so that there is a concern that the bearing 52 may abnormally generate heat due to sliding with the step 60d.

On the other hand, in the first embodiment of the present disclosure, as illustrated in FIG. 5, a part of the gear 55 is disposed to cover a part of the first portion 60a. Even if the gear 55 is disposed to be shifted to the right in FIG. 5, a part of the bearing 52 can be prevented or restricted from protruding to the right from the step 60d of the rotation shaft 60. In other words, the bearing 52 is disposed in advance at a position on the left of the step 60d by the amount by which the gear 55 covers a part of the first portion 60a. Even if the bearing 52 is slightly displaced to the right due to the displacement of the gear 55, the bearing 52 can be prevented or restricted from protruding from the step 60d. Such a configuration can prevent or restrict a decrease in the sliding area of the bearing 52 with respect to the rotation shaft 60 (the first portion 60a) and maintain the sliding area of the bearing 52. Thus, the durability can be maintained. Further, abnormal heat generation due to sliding of the bearing 52 with respect to the step 60d can be restricted.

A description is given of a method of mounting the bearing 52 and the gear 55 according to the first embodiment of the present disclosure.

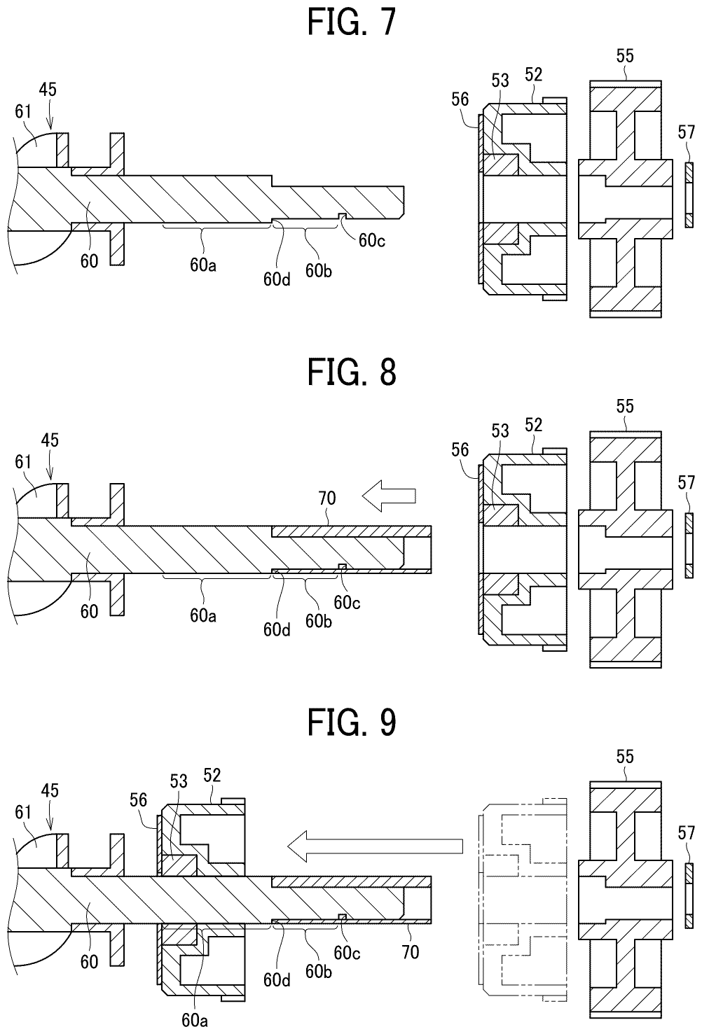

In the first embodiment of the present disclosure, when the bearing 52 and the gear 55 are mounted onto the rotation shaft 60, first, as illustrated in FIG. 7, the seal 53 and the sheet member 56 are assembled to the bearing 52 in advance. Then, a bearing unit in which the bearing 52, the seal 53, and the sheet member 56 are united is configured.

Next, as illustrated in FIG. 8, a cylindrical guide 70 (a mounting jig) is mounted onto the rotation shaft 60. The guide 70 is a cylindrical member having a thickness substantially equal to the height of the step 60d of the rotation shaft 60, and is mounted onto the outer circumferential surface of the second portion 60b so that the tip of the guide 70 abuts against the step 60d of the rotation shaft 60. In this manner, when the guide 70 is mounted onto abut against the step 60d, the outer circumferential surface of the guide 70 is disposed to be continuous with (on the same surface as) the outer circumferential surface of the first portion 60a, so that the step portion 60d of the rotation shaft 60 disappears visually.

As illustrated in FIG. 9, in a state where the guide 70 is mounted on the rotation shaft 60, the bearing unit (the bearing 52, the seal 53, and the sheet member 56) is mounted onto the first portion 60a of the rotation shaft 60. At this time, the bearing 52 and the seal 53 are guided from the outer circumferential surface of the guide 70 to the outer circumferential surface of the first portion 60a along the outer circumferential surface of the guide 70, so that the bearing 52 and the seal 53 can be prevented from being caught by the step 60d. Such a configuration enables the bearing unit to be smoothly mounted onto the rotation shaft 60. The bearing 52 and the seal 53 are prevented from being caught by the step 60d. Thus, the bearing 52 and the sheet member 56 are prevented from being damaged, and the occurrence of an inconvenience such as the seal 53 mounted in an inclined manner can be prevented.

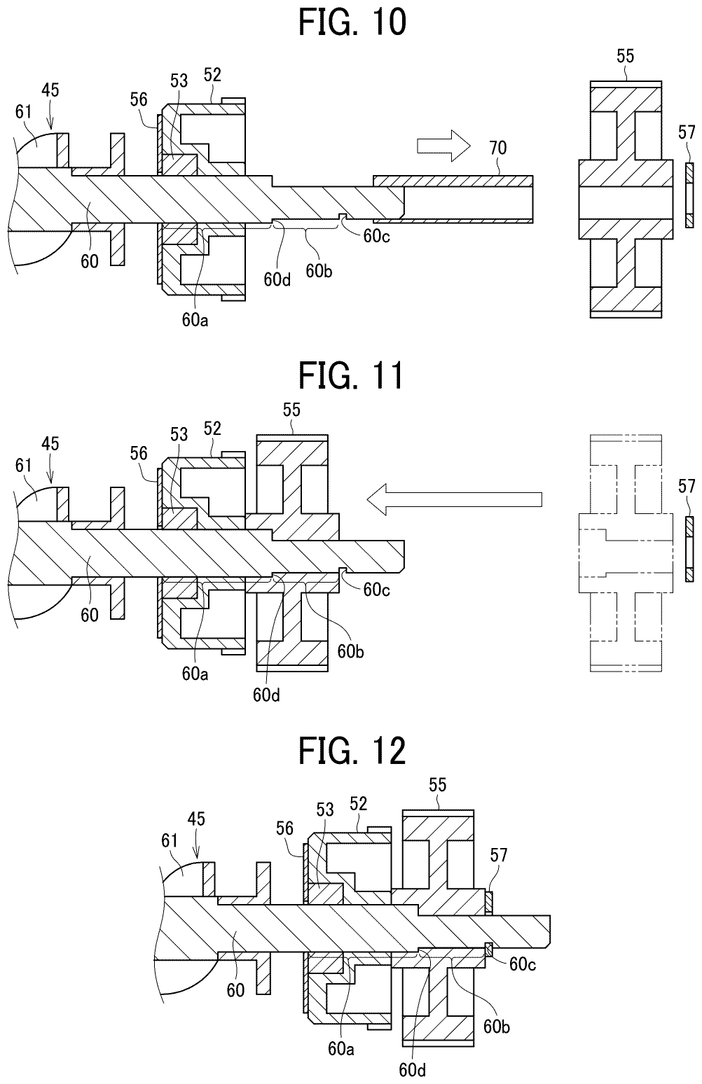

After the bearing 52 is mounted onto the rotation shaft 60, the gear 55 is mounted. Before that, as illustrated in FIG. 10, the guide 70 is detached from the rotation shaft 60. As a result, the second portion 60b of the rotation shaft 60 is exposed again.

As illustrated in FIG. 11, the gear 55 is mounted onto the outer circumferential surface of the second portion 60b. At this time, the gear 55 is moved until the gear 55 abuts against the step 60d of the rotation shaft 60, so that the movement of the gear 55 in the installation direction (inward in the axial direction) is restricted, and the gear 55 is positioned.

As illustrated in FIG. 12, in a state where the gear 55 is mounted on the rotation shaft 60, the retaining member 57 is mounted onto the engagement groove 60c of the rotation shaft 60, so that the movement of the gear 55 in the removal direction (outward in the axial direction) is restricted. Such a configuration prevents the gear 55 and the bearing 52 from falling off from the rotation shaft 60. In this manner, the installation of the bearing 52 and the gear 55 is completed.

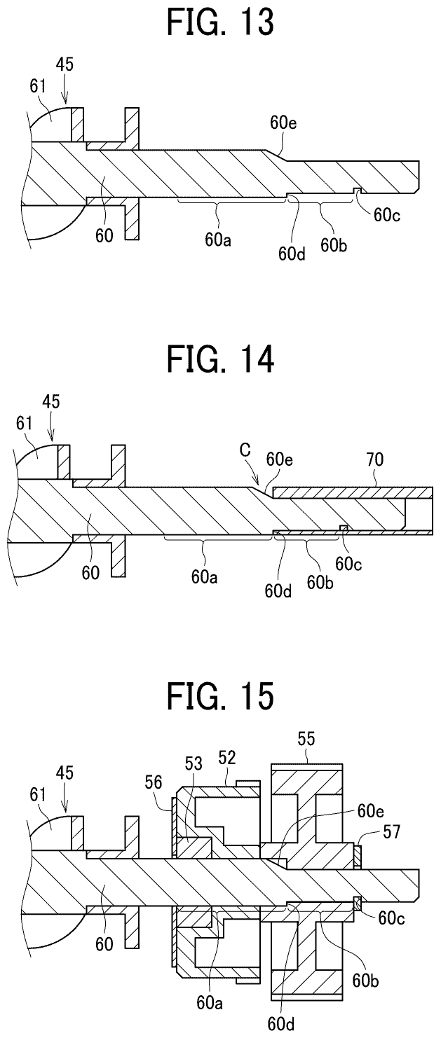

In the first embodiment of the present disclosure, the step 60d is formed by a surface orthogonal to the axial direction of the rotation shaft 60 over the entire circumference. However, as in the example of FIG. 13, a part of the first portion 60a of the rotation shaft 60 may have an inclined surface 60e inclined with respect to the axial direction of the rotation shaft 60. The inclined surface 60e is provided to be continuous with the flat surface (D-cut portion) toward the second portion 60b. As described above, the rotation shaft 60 may have a configuration in which a part of the first portion 60a may have the inclined surface 60e. Even with such a configuration, the outer circumferential surfaces of the first portion 60a and the second portion 60b of the rotation shaft 60 are formed to be completely distinguished from each other. Thus, the surface of a part (the second portion 60b) of the rotation shaft 60 can be roughened, and the manufacturing cost can be reduced as in the first embodiment of the present disclosure.

In the case of the example of FIG. 13, if the cylindrical guide 70 is mounted onto the rotation shaft 60 when the bearing unit is mounted onto the rotation shaft 60 as illustrated in FIG. 14, a step C is formed at the position of the inclined surface 60e, so that there is a possibility that the bearing unit may not be smoothly mounted. Accordingly, in order to smoothly mount the bearing unit, it is preferable to select an example in which the step 60d is formed by a surface orthogonal to the axial direction over the entire circumference of the rotation shaft 60 as in the first embodiment of the present disclosure.

In the example of FIG. 13, the gear 55 is disposed to cover the entire of the inclined surface 60e as illustrated in FIG. 15, and thus a decrease in the sliding area of the bearing 52 due to the displacement of the gear 55 and the bearing 52 can be prevented or restricted.

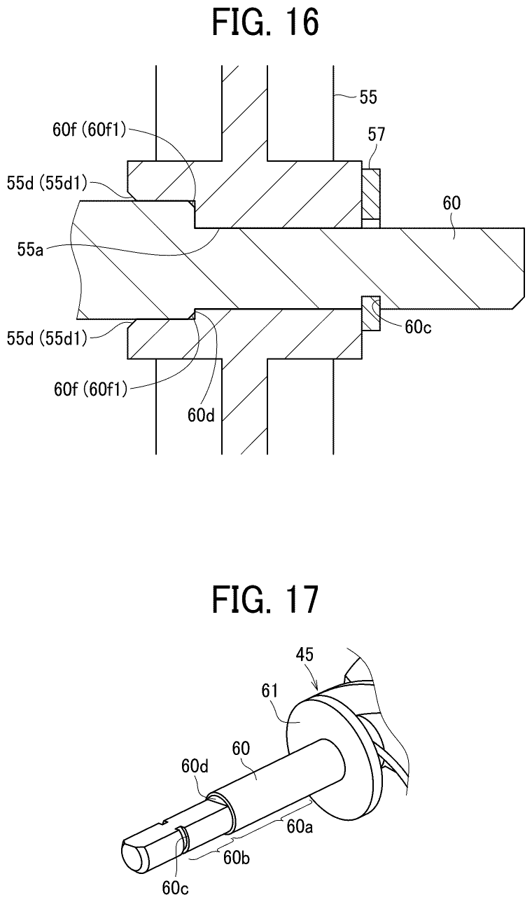

As in the example of FIG. 16, each of a corner portion 60f on the outer diameter side of the step 60d of the rotation shaft 60 and a corner portion 55d of the opening edge of the insertion hole 55a of the gear 55 may have an inclined surface 60f1 and an inclined surface 55d1 inclined with respect to the axial direction. The inclined surface 60f1 and the inclined surface 55d1 are tapered inclined surfaces provided over the entire circumferential direction of the step 60d and the insertion hole 55a. The inclined surface 60f1 and the inclined surface 55d1 are provided, so that the step 60d of the rotation shaft 60 and the opening edge of the insertion hole 55a of the gear 55 can be prevented from being caught when the gear 55 is mounted onto the rotation shaft 60. Thus, the installation work of the gear 55 can be smoothly performed. One of the rotation shaft 60 and the gear 55 may have the inclined surface 60f1 or the inclined surface 55d1.

Other embodiments of the present disclosure are described below. In the following description, a description is mainly given of the parts different from those of the first embodiment of the present disclosure, and the description of the same parts are appropriately omitted.

### Second Embodiment

FIG. 17 is a perspective view of a conveying screw 45 according to a second embodiment of the present disclosure.

In the first embodiment of the present disclosure described above, the rotation shaft 60 and the blade 61 are made of different materials. However, in the second embodiment of the present disclosure illustrated in FIG. 17, the rotation shaft 60 and the blade 61 are both integrally molded of a resin material. As described above, the conveying screw 45 may be integrally molded of a resin material.

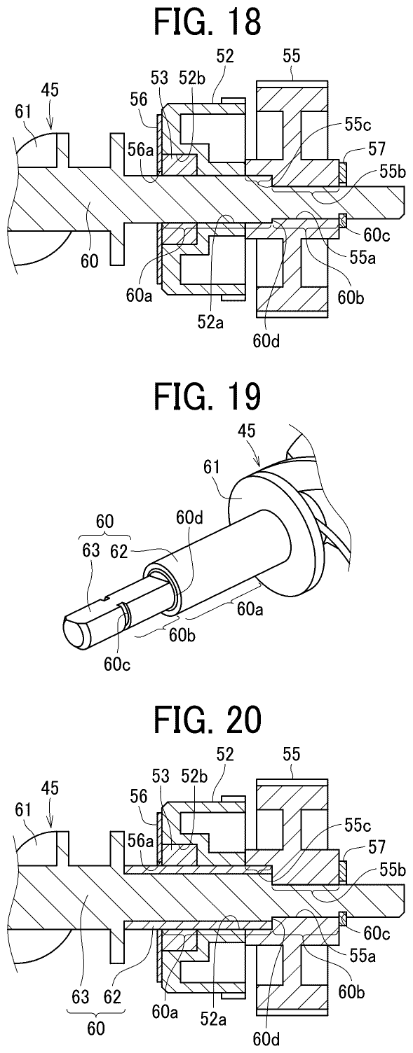

FIG. 18 is a diagram illustrating a state in which the bearing 52 and the gear 55 are mounted on the conveying screw 45 according to the second embodiment of the present disclosure.

As illustrated in FIG. 18, in the second embodiment of the present disclosure, the gear 55 is disposed to cover a part of the first portion 60a, so that the dimensional tolerance of the gear 55 can be relaxed in the portion (the large-diameter inner circumferential surface 55c) covering the first portion 60a. Accordingly, in the second embodiment of the present disclosure, the dimensional tolerance of the gear 55 can be relaxed, and the manufacturing cost can be reduced as in the first embodiment of the present disclosure.

In the second embodiment of the present disclosure, the rotation shaft 60 also has the large-diameter first portion 60a and the small-diameter second portion 60b, so that the outer circumferential surface of the rotation shaft 60 is completely distinguished between the first portion 60a and the second portion 60b. For this reason, in the second embodiment of the present disclosure, the surface roughness of the second portion 60b can be roughened, and the cost for surface processing can be reduced.

### Third Embodiment

FIG. 19 is a perspective view of a conveying screw 45 according to a third embodiment of the present disclosure.

As illustrated in FIG. 19, in the conveying screw 45 according to the third embodiment of the present disclosure, the rotation shaft 60 includes a base shaft 63 made of resin and a cylindrical member 62 (collar) made of metal and mounted on an outer circumferential surface of the base shaft 63. As described above, the rotation shaft 60 may be formed of two members, i.e., the base shaft 63 made of resin and the cylindrical member 62 made of metal. The cylindrical member 62 includes the large-diameter first portion 60a, and the base shaft 63 exposed from the cylindrical member 62 includes the small-diameter second portion 60b. In this case, the base shaft 63 is integrally molded with the blade 61 made of resin.

FIG. 20 is a diagram illustrating a state in which the bearing 52 and the gear 55 are mounted on the conveying screw 45 according to the third embodiment of the present disclosure.

As illustrated in FIG. 20, in the third embodiment of the present disclosure, the gear 55 is disposed to cover a part of the first portion 60a (cylindrical member 62), so that the dimensional tolerance of the gear 55 can be relaxed in the portion (large-diameter inner circumferential surface 55c) covering the first portion 60a. With such a configuration, in the third embodiment of the present disclosure, the manufacturing cost by relaxing the dimensional tolerance of the gear 55 can be reduced.

In the third embodiment of the present disclosure, the bearing 52 is mounted on the outer circumferential surface of the metallic cylindrical member 62, so that the heat transfer property between the bearing 52 and the rotation shaft 60 (cylindrical member 62) is enhanced. For this reason, even if frictional heat is generated between the rotation shaft 60 and the bearing 52 as the rotation shaft 60 rotates, the frictional heat is easily dispersed through the cylindrical member 62. Thus, a temperature rise of the bearing 52 due to the frictional heat can be reduced. Such a configuration can enhance the durability of the bearing 52.

In the third embodiment of the present disclosure, the outer circumferential surface of the rotation shaft 60 is completely distinguished between the cylindrical member 62 including the first portion 60a and the base shaft 63 including the second portion 60b. Thus, the surface roughness of the base shaft 63 (second portion 60b) can be roughened, and the cost for surface processing can be reduced.

### Fourth Embodiment

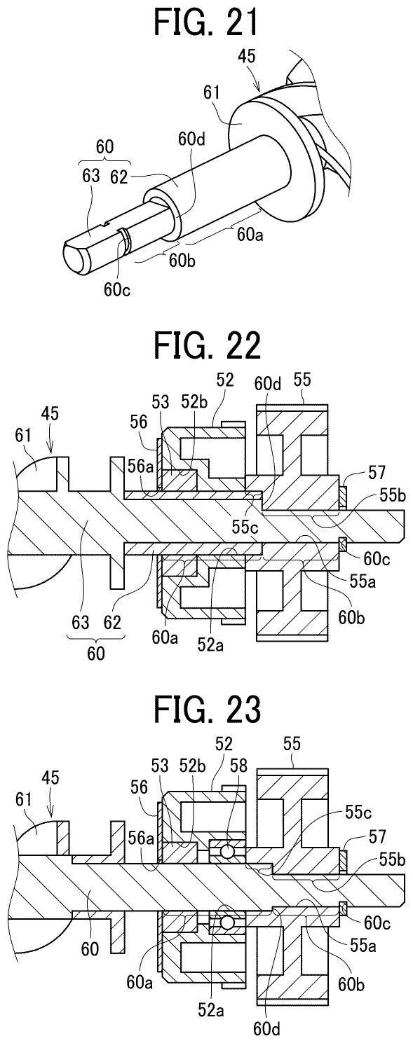

FIG. 21 is a perspective view of a conveying screw 45 according to a fourth embodiment of the present disclosure.

As illustrated in FIG. 21, in the conveying screw 45 according to the fourth embodiment of the present disclosure, the rotation shaft 60 includes the base shaft 63 made of resin and the cylindrical member 62 made of metal, as in the third embodiment of the present disclosure described above. However, the configuration of the base shaft 63 is different.

Specifically, in the fourth embodiment of the present disclosure, as illustrated in FIG. 22, the outer circumferential surface of the portion corresponding to the first portion 60a of the base shaft 63 and the outer circumferential surface of the portion corresponding to the second portion 60b are continuous on the same plane over the axial direction (except for the D-cut portion). In other words, the base shaft 63 is not configured such that the outer circumferential surface is completely distinguished between the portion corresponding to the first portion 60a and the portion corresponding to the second portion 60b. For this reason, in the fourth embodiment of the present disclosure, unlike the third embodiment of the present disclosure, there is a disadvantage that it is difficult to process the base shaft 63 to have different surface roughness.

In the fourth embodiment of the present disclosure, as in the third embodiment of the present disclosure, the gear 55 covers a part of the large-diameter first portion 60a formed by the cylindrical member 62 of the rotation shaft 60. Thus, the dimensional tolerance of the large-diameter inner circumferential surface 55c of the gear 55 covering the first portion 60a can be relaxed, and the manufacturing cost of the gear 55 can be reduced. Accordingly, even if the outer circumferential surfaces of the first portion 60a and the second portion 60b of the rotation shaft 60 are continuous on the same plane, the structure of the gear 55 covering a part of the first portion 60a can reduce the manufacturing cost of the gear 55 as in the above-described embodiments of the present disclosure.

### Fifth Embodiment

FIG. 23 is a diagram illustrating a configuration of a bearing 52 according to a fifth embodiment of the present disclosure.

As illustrated in FIG. 23, in the fifth embodiment of the present disclosure, the bearing 52 includes a rolling bearing 58. As described above, the bearing 52 may include the rolling bearing 58 instead of the sliding bearing. In FIG. 23, a ball bearing in which a plurality of balls are interposed between an outer ring and an inner ring is used as the rolling bearing 58. However, the rolling bearing 58 may be, for example, a roller bearing having a cylindrical roller, a needle roller, or a tapered roller, instead of the balls.

In the configuration using the bearing 52 having the rolling bearing 58, an inconvenience of the reduction in the sliding area due to the displacement of the bearing 52 in the axial direction as described above does not occur. However, when the bearing 52 is displaced in the axial direction so that the contact area between the rolling bearing 58 and the rotation shaft 60 (the first portion 60a) is reduced, an inconvenience may occur that the pressure applied to the rolling bearing 58 from the rotation shaft 60 is increased and the durability is decreased.

For this reason, in the fifth embodiment of the present disclosure, the gear 55 is disposed to cover the first portion 60a as illustrated in FIG. 23. With such a configuration, even when the gear 55 and the bearing 52 are displaced to the right in FIG. 23, a decrease in the contact area between the rolling bearing 58 and the rotation shaft 60 due to the displacement can be prevented or restricted, and the durability of the bearing 52 can be maintained.

Although the embodiments of the present disclosure have been described above, the present disclosure is not limited to the configurations according to the above-described embodiments, and design changes can be made as appropriate without departing from the gist of the disclosure. At least two of the configurations of the embodiments may be combined. In each of the above-described embodiments, descriptions are given of the mounting structure of the bearing and the power transmitter (gear) with respect to the conveying screw with an example of the conveying screw that conveys developer in the developing device. The present disclosure is also applicable to, for example, a mounting structure related to a conveyor that conveys (replenishes) toner from a toner container (toner bottle) to the developing device, and a mounting structure related to a conveyor that conveys powder other than the developer and the toner.

The above-described aspects of the present disclosure include at least the following aspects.

### First Aspect

A mounting structure includes a rotation shaft (e.g., the rotation shaft 60), a bearing (e.g., the bearing 52), and a power transmitter (e.g., the gear 54). A conveyor (e.g., the conveying screw 45) including the rotation shaft conveys powder. The bearing rotatably supports the rotation shaft. The power transmitter transmits a rotational force to the rotation shaft. The rotation shaft has a first portion (e.g., the first portion 60a) having an outer circumferential surface on which the bearing is mounted and a second portion (e.g., the second portion 60b) having an outer circumferential surface on which the power transmitter is mounted. The outer circumferential surface of the second portion is an outer circumferential surface having a non-circular cross section located inside the outer circumferential surface of the first portion when viewed from an axial direction of the rotation shaft. The power transmitter is locked to the outer circumferential surface of the second portion and is mounted to cover a part of the outer circumferential surface of the first portion.

### Second Aspect

In the mounting structure according to the first aspect, a fitting tolerance between the power transmitter (e.g., the gear 54) and the part of the first portion (e.g., the first portion 60a) covered by the power transmitter is larger than a fitting tolerance between the power transmitter and the second portion (e.g., the second portion 60b) to which the power transmitter is locked.

### Third Aspect

In the mounting structure according to the first or second aspect, the power transmitter (e.g., the gear 54) is restricted from moving in the axial direction of the rotation shaft (e.g., the rotation shaft 60) by a step (e.g., the step 60d) formed between the first portion (e.g., the first portion 60a) and the second portion (e.g., the second portion 60b).

### Fourth Aspect

In the mounting structure according to any one of the first to third aspects, a corner portion (e.g., the corner portion 60f) on an outer diameter side of the step (e.g., the step 60d) formed between the first portion (e.g., the first portion 60a) and the second portion (e.g., the second portion 60b) has an inclined surface (e.g., the inclined surface 60e) inclined with respect to the axial direction of the rotation shaft (e.g., the rotation shaft 60).

### Fifth Aspect

In the mounting structure according to any one of the first to fourth aspects, the power transmitter (e.g., the gear 54) has an insertion hole (e.g., the insertion hole 55a) through which the rotation shaft (e.g., the rotation shaft 60) is inserted, and a corner portion (e.g., the corner portion 55d) of an opening edge of the insertion hole has an inclined surface (e.g., the inclined surface 60e) inclined with respect to the axial direction of the rotation shaft.

### Sixth Aspect

The mounting structure according to any one of the first to fifth aspects further includes a seal (e.g., the seal 53) between the bearing (e.g., the bearing 52) and the outer circumferential surface of the first portion (e.g., the first portion 60a).

### Seventh Aspect

The mounting structure according to the sixth aspect further includes a sheet member (e.g., the sheet member 56) to cover a gap between the bearing (e.g., the bearing 52) and the seal (e.g., the seal 53).

### Eighth Aspect

In the mounting structure according to any one of the first to seventh aspects, the rotation shaft (e.g., the rotation shaft 60) is made of a resin material.

### Ninth Aspect

In the mounting structure according to any one of the first to seventh aspects, the rotation shaft (e.g., the rotation shaft 60) includes a base shaft (e.g., the base shaft 63) made of resin and a cylindrical member (e.g., the cylindrical member 62) made of metal, wherein the cylindrical member is disposed on an outer circumferential surface of the base shaft, and the bearing (e.g., the bearing 52) is mounted on the cylindrical member.

### Tenth Aspect

In the mounting structure according to any one of the first to ninth aspects, the bearing (e.g., the bearing 52) includes a rolling bearing (e.g., the rolling bearing 58) that rotatably supports the rotation shaft (e.g., the base shaft 63).

### Eleventh Aspect

A developing device (e.g., the developing device 13) includes a conveyor (e.g., the conveying screw 45) that conveys developer, a bearing (e.g., the bearing 52) that rotatably supports the conveyor, and a power transmitter (e.g., the gear 54) that transmits a rotational force to the conveyor. The developing device uses the mounting structure according to any one of the first to tenth aspects, as a mounting structure that mounts the bearing and the power transmitter on the rotation shaft (e.g., the rotation shaft 60) of the conveyor.

### Twelfth Aspect

An image forming apparatus (e.g., the image forming apparatus 100) includes the mounting structure according to any one of the first to tenth aspects or the developing device (e.g., the developing device 13) according to the eleventh aspect.

The above-described embodiments are illustrative and do not limit the present disclosure. Thus, numerous additional modifications and variations are possible in light of the above teachings. For example, elements and/or features of different illustrative embodiments may be combined with each other and/or substituted for each other within the scope of the present disclosure.

1. A mounting structure comprising:
a rotation shaft of a conveyor to convey powder, the rotation shaft having:
a first portion having a first outer circumferential surface; and
a second portion:
adjacent to the first portion in an axial direction of the rotation shaft; and
having a second outer circumferential surface inside the first outer circumferential surface of the first portion in a cross-section orthogonal to the axial direction, the second outer circumferential surface having a non-circular cross section;
a bearing on the first portion of the rotation shaft, the bearing rotatably supporting the rotation shaft; and
a power transmitter:
covering a part of the first outer circumferential surface of the first portion; and
engaged with the second outer circumferential surface of the second portion to transmit a rotational force to the rotation shaft.

2. The mounting structure according to claim 1, having:
a first fitting tolerance between the power transmitter and the part of the first outer circumferential surface of the first portion; and
a second fitting tolerance between the power transmitter and the second portion, the second fitting tolerance smaller than the first fitting tolerance.

3. The mounting structure according to claim 1,
wherein the rotation shaft has a step between the first portion and the second portion in the axial direction, and
wherein the step restricts a movement of the power transmitter in the axial direction.

4. The mounting structure according to claim 1,
wherein the rotation shaft has a step between the first portion and the second portion in the axial direction, and
wherein the step has an inclined surface:
inclined with respect to the axial direction; and
on a corner portion of the first portion.

5. The mounting structure according to claim 1,
wherein the power transmitter has an insertion hole through which the rotation shaft is inserted, and
wherein the insertion hole has:
an opening edge of the insertion hole, the opening edge having a corner portion; and
an inclined surface on the corner portion, the inclined surface inclined with respect to the axial direction.

6. The mounting structure according to claim 1, further comprising a seal between the bearing and the first outer circumferential surface of the first portion.

7. The mounting structure according to claim 6, further comprising a sheet member to cover a gap between the bearing and the seal.

8. The mounting structure according to claim 1,
wherein the rotation shaft is made of a resin material.

9. The mounting structure according to claim 1,
wherein the rotation shaft includes:
a base shaft made of resin; and
a cylindrical member made of metal, the cylindrical member on an outer circumferential surface of the base shaft, and
wherein the bearing is mounted on the cylindrical member.

10. The mounting structure according to claim 1,
wherein the bearing includes a rolling bearing rotatably supporting the rotation shaft.

11. A developing device comprising:
the mounting structure according to claim 1; and
the conveyor to convey developer, the conveyor including the rotation shaft,
wherein the bearing rotatably supports the rotation shaft of the conveyor, and
wherein the power transmitter transmits the rotational force to the conveyor.

12. An image forming apparatus comprising the developing device according to claim 11.
